(19) United States
(12) Patent Application Publication
(10) Pub. No.: US 2013/0210426 A1
(43) Pub. Date: Aug. 15, 2013

(54) COMMUNICATION NETWORK SELECTION

(71) Applicants: Mika Forssell, Soderkulla (FI); Veli-Matti Teittinen, Nummela (FI)

(72) Inventors: Mika Forssell, Soderkulla (FI); Veli-Matti Teittinen, Nummela (FI)

(73) Assignee: NOKIA SIEMENS NETWORKS OY, Espoo (FI)

(21) Appl. No.: 13/812,860

(22) PCT Filed: Aug. 16, 2010
(86) PCT No.: PCT/EP2010/061872

§ 371 Date: Apr. 29, 2013

(51) Int. Cl. H04W 8/06

(52) U.S. Cl. CPC H04W 8/06
USPC 455/433

(57) ABSTRACT

The present invention relates to methods and apparatus for improving communication network selection on a mobile device 102. Once an element 105 of a Home Communication Service Provider (HCSP) in a Home communication network 104 is aware that a mobile device 102 is roaming then information for one or more communication networks 103, 108 based on one or more parameters may be requested from a database 106. The database 106 may identify the one or more communication networks 103, 108 and provide information relating to the one or more communications networks 103, 108 such that a communication message may be transmitted to the roaming mobile device 102 where the communication message may include the one or more communication networks 103, 108 and the information for each of said one or more communication networks 103, 108 to enable a selection of one of the one or more communication networks 103, 108.

The present invention relates to an improved network selection and, in particular, to enabling the selection of a visitor network on a device.

Presently, there are many communication networks available that are operated by various Communication Service Providers (CSPs) offering a wide variety of networks and services. The CSPs typically have many subscribers often in the thousand or hundreds of thousands.

A subscriber is typically a user who has a subscription with one CSP (typically known as the Home CSP (HCSP) to utilise the communication network associated with the CSP.

A mobile device is a device that is mobile and able to connect to or attach with communication networks, for example, a mobile device may be a mobile telephone, a laptop, a tablet device, a Personal Digital Assistant (PDA), and so on. Typically, a subscriber's mobile device will connect with the communication network associated with their HCSP in order to receive and transmit communications and data to and from the mobile device.

However, when a mobile device is unable to connect to or attach with the communication network associated with their HCSP, for example, if the mobile device moves to a location that is not served by the communication network associated with their HCSP, then in this situation, the mobile device may attempt to connect with a communication network operated by another CSP, which is typically known as a Visitor CSP (VCSP). The process of a mobile device connecting to and utilising a communication network operated by a VCSP is often referred to as roaming.

The HCSP and VCSPs may have reciprocal agreements in order to allow mobile devices subscribed to the HCSP to utilise the communication network operated by the VCSPs. However, the HCSP typically configures the subscriber's mobile device with a predefined list of VCSPs that the HCSP would prefer the mobile device to connect to. The preferred VCSPs is stored in memory of the mobile device in priority order and when the mobile device detects communication networks it will connect to the communication network that is operated by the VCSP that is highest in the predefined list.

If the mobile device does not include a list of predefined

VCSPs or if a communication network operated by a VCSP in the list is not detected then the mobile device will either simply connect to one of the communication networks detected based on preconfigured rules in the mobile device or simply list the detected communication networks to the subscriber.

Thus, the selection of a communication network operated by a VCSP is performed automatically based on the preferences of the HCSP, performed automatically based on rules stored in the mobile device, or via an arbitrary selection by a subscriber.

Accordingly, there is a need to provide an improved communication network selection process for a subscriber via their mobile device. Many of the embodiments of the present invention seek to address at least part of the above identified need.

According to a first aspect of the present invention there is provided a method comprising the steps of: generating a request message relating to a roaming mobile device wherein the request message includes one or more parameters and requests information for one or more communication networks based on the one or more parameters; and transmitting the request message to a database; such that a communication message is transmitted to the roaming mobile device wherein the communication message includes the one or more communication networks and the information for each of the one or more communication networks to enable a selection of one of the one or more communication networks.

Thus, for a roaming mobile device, for example, a mobile device that may be unable to connect to or attach with a communication network to which the mobile device (or user of the mobile device) is subscribed to, a request message is generated to request information for one or more communication networks based on one or more parameters included in the generated request message. The request message is transmitted to a database such that the information for each of the communication networks may be transmitted to the roaming mobile device by a communication message thereby enabling the selection of one of the communication networks based on the information given for each communication network. The selection may be made by a user of the roaming mobile device or may be made automatically based on rules or criteria in the roaming mobile device.

The request message transmitted to the database may be any message for interacting with the database. For example, the request message may be a Structured Query Language (SQL) request message.

The roaming mobile device may be a mobile telephone, a laptop, a tablet device, a Personal Digital Assistant (PDA) and so on. In other words, a mobile device may be a device that is mobile and has the ability to connect to, or attach with, communication networks.

The communication networks may be cellular networks, mobile networks, Wi-Fi networks, WiMAX networks, LTE networks, and so on. In other words, the communication network may be any communication network that enables a mobile device to connect to, or attach with, it in order to transmit and/or receive communications.

The information may include the tariff, quality of service, availability, services/functionality provided, signal strength, type of communication network (e.g. cellular, Wi-Fi, WiMAX), available detected, determined or identified communication networks, and so on.

Accordingly, the method improves communication network selection for a roaming mobile device as information for each of one or more communication networks based on one or more parameters in the request message is requested for the roaming mobile device such that the roaming mobile device is enabled to select one of the communication networks.

The one or more parameters may include location data for a location of the roaming mobile device. Therefore, the request message may request information for the one or more communication networks based on the location of the roaming mobile device. In other words, the generated request message may request information for one or more communication networks that serve the location of the roaming mobile device.

The one or more parameters may include one or more detected communication networks that were detected by the roaming mobile device. Therefore, the request message may request information for the one or more communication networks based on the communication networks that may have been detected by the roaming mobile device. In other words, information may be requested for the communication networks that may have been detected by the roaming mobile device. The one or more parameters may further include location data for a location of the roaming mobile device to request information for one or more communication networks that serve the location of the mobile device.

The method may further comprise the steps of receiving a response message from the database wherein the response message includes information for one or more communication networks identified by the database based on the one or more parameters; generating the communication message based on the received response message; and transmitting the communication message to the roaming mobile device.

Thus, a response message may be received from the database where the response message may include the requested information for the one or more communication networks based on the one or more parameters in the request message. The communication message may be generated by the method and based on the received response message.

The communication message may be any communication message that may be transmitted to the mobile device, for example, a Short Message Service (SMS) message, Multimedia Message Service (MMS) message, Open Mobile Alliance Device Management (OMA DM) messages, e-mail, web page, and so on.

The communication message may include the one or more communication networks and the information for each one or more communication networks as a selectable link in the communication message. Therefore, the communication message is generated to include the one or more communication networks as selectable links such that a user of the mobile device may be able to select their preferred communication network directly from the received communication message via the roaming mobile device. The selectable links may include a clickable link, a numbered list where the user may select the corresponding number to their preferred communication network, and so on.

The communication message may be generated as a series of commands which may be interpreted by the roaming mobile device on receipt of the communication message in order to display the list of available mobile operators in a graphical user interface on a display of the roaming mobile device.

The communication message generated may be further based on any offers or campaigns that a communication network operator to which the user is subscribed is running or offering to the user.

The method may further comprise the step of receiving one or more criteria; and wherein the one or more parameters in the request message may include the one or more criteria. Accordingly, the user of the roaming mobile device, the home network operator, visitor network operator, or any combination thereof may provide one or more criteria where the one or more parameters may include the one or more criteria. For example, the user may specify the information the user wishes to receive in order to enable the user to select on the roaming mobile device. The user may provide the one or more criteria via the roaming mobile device or by another communication device, for example, a personal computer, laptop, and so on.

The method may further comprise the step of receiving a roaming update message wherein the update message relates to the roaming mobile device. The roaming update message may include one or more of location data for the roaming mobile device, an indication of a communication network that the roaming mobile device is attached to, an indication of a communication network operator, a list of one or more communication networks that may be detected by the roaming mobile device, an indication of the location of the roaming mobile device to enable the location of the roaming mobile device to be determined. The roaming update message may be received from a communication network operator of the communication network that the roaming mobile device may be connected to, may be received from the roaming mobile device, or a combination thereof.

The method may further comprise transmitting a communication network update message to the database in order to update the information stored in the database for one or more communication networks.

The method may be for operating a server, for operating a Home Location Register in the communication network management system of the communication network operator to which the roaming mobile device is subscribed, or for operating any other entity or system in the communication networks.

According to a second aspect of the present invention there is provided an apparatus comprising: a first processor adapted to generate a request message relating to a roaming mobile device wherein the request message includes one or more parameters and requests information for one or more communication networks based on the one or more parameters; and a first output adapted to transmit the request message to a database; such that a communication message is transmitted to the roaming mobile device wherein the communication message includes the one or more communication networks and the information for each of the one or more communication networks to enable a selection of one of the one or more communication networks.

According to a third aspect of the present invention there is provided an apparatus adapted to generate a request message relating to a roaming mobile device wherein the request message includes one or more parameters and requests information for one or more communication networks based on the one or more parameters; and transmit the request message to a database; such that a communication message is transmitted to the roaming mobile device wherein the communication message includes the one or more communication networks and the information for each of the one or more communication networks to enable a selection of one of the one or more communication networks.

The first processor may be further adapted to include location data for a location of the roaming mobile device in the one or more parameters of the request message.

The first processor may be further adapted to include one or more detected communication networks that were detected by the roaming mobile device in the one or more parameters.

The apparatus may further comprise a first input adapted to receive a response message from the database wherein the response message includes the information for one or more communication networks identified by the database based on the one or more parameters; a second processor adapted to generate the communication message based on the received response message; and a second output adapted to transmit the communication message to the roaming mobile device.

The apparatus may further comprise a second input adapted to receive one or more criteria; and wherein the first processor is further adapted to include the one or more criteria in the one or more parameters of the request message.

The apparatus may further comprise a third input adapted to receive a roaming update message wherein the roaming update message relates to the roaming mobile device.

The apparatus may further comprise any further means, processors, inputs and outputs for performing any or all of the functions in accordance with the aspects of the invention.

The apparatus may be a server or a computing device. The apparatus may be a Home Location Register or may be another telecommunication network element, management system or another system.

The apparatus may be adapted by hardware, software or any combination thereof. The first input, second input and third input may be the same input, different inputs or any combination thereof. The first output and second output may be the same output or different outputs. The first processor and second processor may be the same processor or different processors.

According to a fourth aspect of the present invention there is provided a computer program product comprising computer readable executable code for: generating a request message relating to a roaming mobile device wherein the request message includes one or more parameters and requests information for one or more communication networks based on the one or more parameters; and transmitting the request message to a database; such that a communication message is transmitted to the roaming mobile device wherein the communication message includes the one or more communication networks and the information for each of the one or more communication networks to enable a selection of one of the one or more communication networks.

The computer program product may further comprise computer readable executable code for performing any or all of the functions in accordance with the aspects of the invention.

According to a fifth aspect of the present invention there is provided a method comprising the steps of: receiving a request message relating to a roaming mobile device wherein the request message includes one or more parameters and requests information for one or more communication networks based on the one or more parameters; and identifying the information for the one or more communication networks based on the one or more parameters; such that a communication message is transmitted to the roaming mobile device wherein the communication message includes the one or more communication networks and the information for each of the one or more communication networks to enable a selection of one of the one or more communication networks.

Therefore, a request message relating to a roaming mobile device is received and, based on the one or more parameters in the request message, information for one or more communication networks is identified such that the information for each of the communication networks may be transmitted to the roaming mobile device by a communication message thereby enabling the roaming mobile device or the user of the roaming mobile device to select one of the communication networks based on the information given for each communication network.

The roaming mobile device may be a mobile telephone, a laptop, a tablet device, a Personal Digital Assistant (PDA) and so on. In other words, the mobile device may be any device that is mobile and has the ability to connect to, or attach with, communication networks.

The communication networks may be cellular networks, mobile networks, Wi-Fi networks, WiMAX networks, LTE networks, and so on. In other words, the communication network may be any communication network that enables a mobile device to connect to, or attach with, it in order to transmit and/or receive communications.

The information may include the tariff, quality of service, availability, services/functionality provided, signal strength, type of communication network (e.g. cellular, Wi-Fi, WiMAX), available detected, determined or identified communication networks, and so on.

Accordingly, the communication network selection may be improved by enabling a roaming mobile device to select one of the communication networks.

The one or more parameters may include location data for a location of the roaming mobile device. Therefore, the information for one or more communication networks may be based on the location of the roaming mobile device. In other words, the generated request message may request information for one or more communication networks that serve the location of the roaming mobile device.

The one or more parameters may include one or more detected communication networks that were detected by the roaming mobile device. Therefore, the request message may request information for the one or more communication networks based on the communication networks that may have been detected by the roaming mobile device. In other words, information may be requested for the communication networks that may have been detected by the roaming mobile device. The one or more parameters may further include location data for a location of the roaming mobile device to request information for one or more communication networks that serve the location of the mobile device.

The method may further comprise the steps of generating a response message wherein the response message includes the identified information for the one or more communication networks; and transmitting the response message to an originator of the received request message. Therefore, a response to the request message may be generated where the response message may include the identified information for the one or more identified communication networks. The response message may be transmitted to the originator of the request message.

The method may further comprise the steps of generating the communication message based on the identified information for the one or more communication networks; and transmitting the communication message to the roaming mobile device. Thus, the method may generate a communication message that may include the identified information for the one or more communication networks based on the one or more parameters in the request message. The generated communication message may be transmitted to the roaming mobile device to enable the roaming mobile device to select one of the communication networks based on the information for the one or more communication networks.

The method may further comprise receiving a communication network update message where the communication network update message may include new or updated information for one or more communication networks; and storing the new or updated information.

The communication message may be any communication message that may be transmitted to the mobile device, for example, a Short Message Service (SMS) message, Multimedia Message Service (MMS) message, OMA DM message and so on.

The method may be for operating a database.

According to a sixth aspect of the present invention there is provided an apparatus comprising: an input adapted to receive a request message relating to a roaming mobile device wherein the request message includes one or more parameters and requests information for one or more communication networks based on the one or more parameters; and a first processor adapted to identify the information for the one or more communication networks based on the one or more parameters; such that a communication message is transmitted to the roaming mobile device wherein the communication message includes the one or more communication networks and the information for each of the one or more communication networks to enable a selection of one of the one or more communication networks.

According to a seventh aspect of the present invention there is provided an apparatus adapted to receive a request message relating to a roaming mobile device wherein the request message includes one or more parameters and requests information for one or more communication networks based on the one or more parameters; and identify the information for the one or more communication networks based on the one or more parameters; such that a communication message is transmitted to the roaming mobile device wherein the communication message includes the one or more communication networks and the information for each of the one or more communication networks to enable a selection of one of the one or more communication networks.

The apparatus may further comprise a second processor adapted to generate a response message wherein the response message includes the identified information for the one or more communication networks; and a first output adapted to transmit the response message to an originator of the received request message.

The apparatus may further comprise a third processor adapted to generate the communication message based on the identified information for the one or more communication networks; and a second output adapted to transmit the communication message to the roaming mobile device.

The apparatus may further comprise any further means, storage means, processors, inputs and outputs for performing any or all of the functions in accordance with the aspects of the invention.

The apparatus may be a database.

The apparatus may be adapted by hardware, software or any combination thereof. The first output and second output may be the same output or different outputs. The first processor, second processor and third processor may be the same processor, different processors or any combination thereof.

According to an eighth aspect of the present invention there is provided a computer program product comprising computer readable executable code for: receiving a request message relating to a roaming mobile device wherein the request message includes one or more parameters and requests information for one or more communication networks based on the one or more parameters; and identifying the information for the one or more communication networks based on the one or more parameters; such that a communication message is transmitted to the roaming mobile device wherein the communication message includes the one or more communication networks and the information for each of the one or more communication networks to enable a selection of one of the one or more communication networks.

The computer program product may further comprise computer readable executable code for performing any or all of the functions in accordance with the aspects of the invention.

According to a ninth aspect of the present invention there is provided a method comprising the steps of: receiving a communication message wherein the communication message includes information for one or more communication networks; displaying the communication message on the mobile device; selecting one of the one or more communication networks; and attaching to the selected communication network.

Therefore, based on the received communication message one of the communication networks can be selected, for example, the user may select the communication network or the mobile device may automatically select the communication network based on rules or criteria stored in the mobile device.

The communication message may include the one or more communication networks as selectable links; and may receive input from the user where the input may be a selection of one of the selectable links. Therefore, a mobile device receives and displays a communication message which includes information for one or more communication networks. The roaming mobile device, based on the selection by the user, can then initiate the necessary steps to attach the roaming mobile device to the selected communication network. A selectable link may include enabling the communication network to be selected directly or as a numbered list enabling the selection of the corresponding number of the communication network.

The communication message may include one or more commands; and the method may further comprise generating a graphical user interface based on the commands.

The method may further comprise storing the selected communication network as a preferred communication network.

According to a tenth aspect of the present invention there is provided a mobile device comprising: a first input adapted to receive a communication message wherein the communication message includes information for one or more communication networks; a display adapted to display the communication message on the mobile device; a selector adapted to select one of the one or more communication networks; and a first processor adapted to attach the mobile device to the selected communication network.

According to an eleventh aspect of the present invention there is provided a mobile device adapted to receive a communication message wherein the communication message includes information for one or more communication networks; display the communication message on the mobile device; select one of the one or more communication networks; and attach to the selected communication network.

The mobile device may further comprise a second input adapted to receive input from a user wherein the input indicates a selection of one of the one or more communication networks.

The communication message may include the one or more communication networks as selectable links; and the input from the user is a selection of one of the selectable links.

The communication message may include one or more commands; and the mobile device may further comprise a second processor adapted to generate a graphical user interface based on the commands.

The mobile device may further comprise storage means to store the selected communication network as a preferred communication network in the mobile device.

The mobile device may further comprise any further means, storage means, processors, inputs and outputs for performing any or all of the functions in accordance with the aspects of the invention.

The mobile device may be adapted by hardware, software or any combination thereof. The first input and second input may be the same input or different inputs. The first processor and second processor may be the same processor or different processors.

According to a twelfth aspect of the present invention there is provided a computer program product comprising computer readable executable code for: receiving a communication message wherein the communication message includes information for one or more communication networks;

displaying the communication message on the mobile device; selecting one of the one or more communication networks; and attaching to the selected communication network.

The computer program product may further comprise computer readable executable code for performing any or all of the functions in accordance with the aspects of the invention.

Embodiments of the present invention will now be described, by way of example only, and with reference to the accompanying drawings in which:

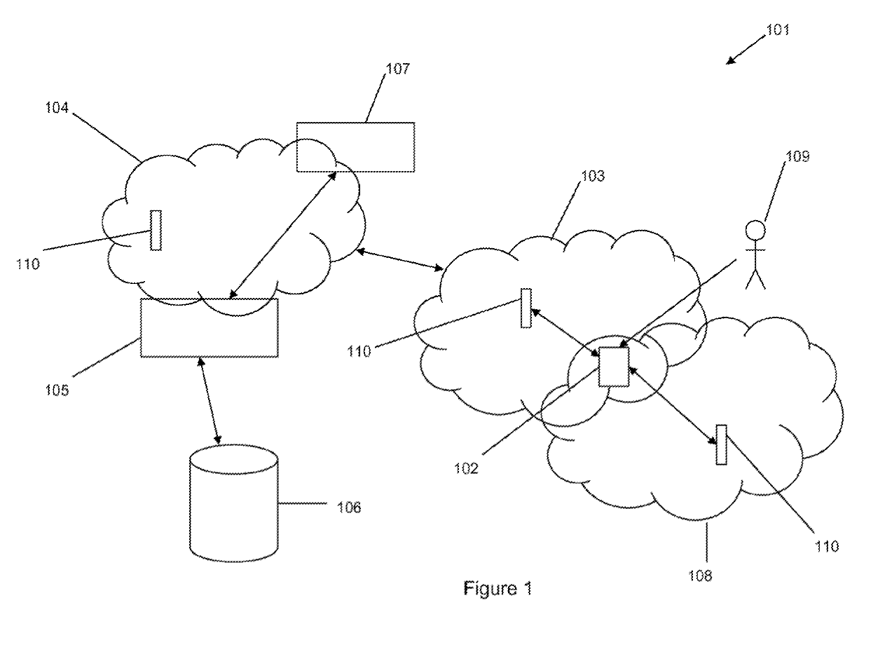

FIG. 1 shows a simplified block diagram of a system in accordance with many of the embodiments of the present invention.

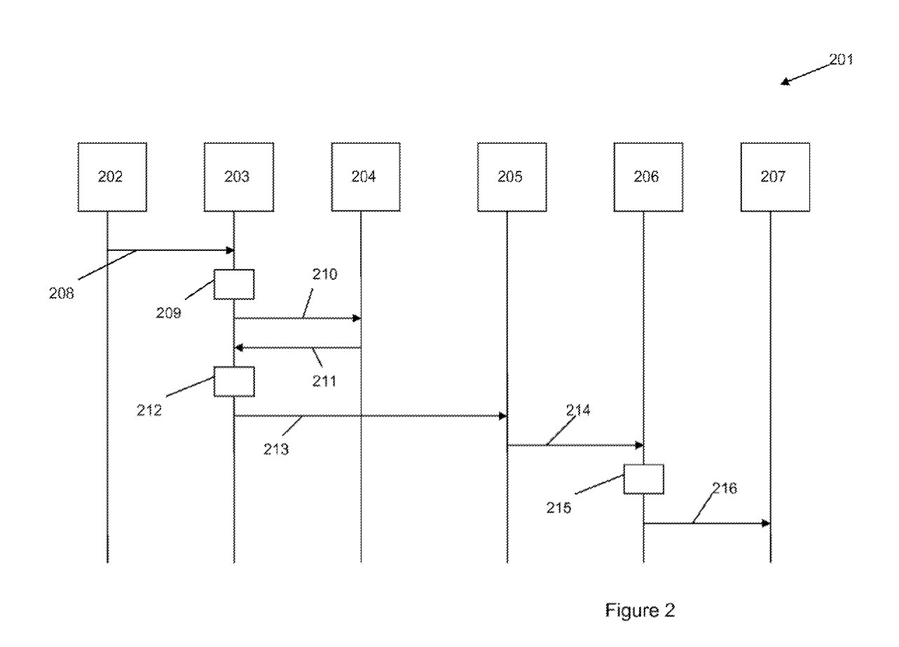

FIG. 2 is a message flow diagram in accordance with many of the embodiments of the present invention.

The embodiments of the present invention enable an improved communication network selection and, in particular, to an improved selection of a visitor communication network by a mobile device when the mobile device is roaming.

As will be appreciated, the present invention may be applied to any type of mobile device (e.g. mobile telephone, smart phone, laptop, tablet device, PDA, and so on) that may connect to any type of communication network (e.g. cellular network, mobile network, Wi-Fi network, WiMAX network, and so on) when the mobile device is unable to connect to the communication network of the CSP that the subscriber of the mobile device is subscribed to.

The following embodiments, with reference to the accompanying Figures, will now be described in relation to mobile telecommunications where the mobile device is a mobile telephone, the HCSP will be referred to as a Home Public Land Mobile Network Operator (HPLMNO) which operates a communication network that will be referred to as a Home Public Land Mobile Network (HPLMN) and the VCSPs will be referred to as a Visitor Public Land Mobile Network Operator (VPLMNO) which operates a Visitor Public Land Mobile Network (VPLMN).

However, as will be appreciated in todays mobile telecommunications the CSPs may be a Mobile Virtual Network Operator (MVNO), a Wi-Fi operator, a WiMAX operator, and so on as mobile telephones presently are able to utilise those and other types of communication networks in order to transmit or receive communications or data. Each CSP may have an associated communication network, whether the CSP own the communication network or rent the communication network from another party.

Referring to FIG. 1, a mobile telecommunication system 101 may include a mobile telephone 102 of a user 109, a Home Public Land Mobile Network (HPLMN) 104 which may be operated by a HPLMN Operator (HPLMNO), a first Visitor Public Land Mobile Network (VPLMN) 103 which may be operated by a first VPLMN Operator (VPLMNO) and a second VPLMN 108 which may be operated by a second VPLMNO.

The HPLMNO may own, manage and maintain the HPLMN 104 or alternatively rent the use of the HPLMN 104 from a third party. Therefore, the HPLMNO may be any mobile operator, a Mobile Virtual Network Operator (MVNO) or any other operator that may be the customer facing provider of mobile services and connectivity. Similarly, a VPLMNO may own, manage and maintain the VPLMN 103, 108 or alternatively rent the use of the VPLMN 103, 108 from a third party. Therefore, the VPLMNO may be any mobile operator, an MVNO or any other operator that may be a provider of mobile services and connectivity.

The networks, HPLMN 104, VPLMN 103, 108 may include one or more Base Transceiver Station (BTS) 110 for receiving communication from and/or transmitting communication to mobile devices 102. For the purpose of describing many of the embodiments, the HPLMN 104 may also include a Home Location Register (HLR) 105, a Short Message Service Centre (SMSC) 107 and a database 106.

However, as will be appreciated, each of the networks, HPLMN 104 and VPLMN 103, 108 may include various other network elements, for example, to enable mobile devices to access the networks, to process and transmit communications across the network, transmission infrastructure, and so on. The networks may also include one or more management systems to monitor and manage the networks and the network elements. The detailed arrangement and architecture of PLMNs are known in the art and therefore not described in detail or shown in detail in the accompanying FIG. 1.

For ease of reference and description, HPLMN 104 will be referred to as Network A and the HPLMNO referred to as Operator A. The first VPLMN 103 will be referred to as Network B and the respective VPLMNO referred to as Operator B. The second VPLMN 108 will be referred to as Network C and the respective VPLMNO referred to as Operator C.

The user 109 may have a subscription with Operator A to utilise the services provided by operator A and to utilise the resources of Network A. Whilst the mobile device 102 is in a location that is served by Operator A then the mobile device 102 may connect with a BTS 110 that is part of Network A in order to transmit and/or receive communications via Operator A.

However, if the mobile device 102 is unable to connect to its home communication network (Network A) operated by Operator A, for example, the mobile device has moved to a location that is not served or covered by Operator A, then the mobile device 102 may connect with a VPLMN operated by a VPLMNO which serves the location of the mobile device 102. As mentioned hereinabove, the mechanism or process of connecting to or attaching with a VPLMNO is typically known as roaming.

In the example shown in FIG. 1, mobile device 102 has moved to a location that may be served by Network B 103 and Network C 108 but is not served by the home network, e.g. Network A 104, or Operator A to which the mobile device 102 is subscribed. For example, the user 109 may have travelled to a different country which is not served by Network A 104 and/or Operator A. In general the conventional or typical roaming process includes the following steps:

1. When the mobile device 102 is turned on it may determine that the HPLMN is not available. The mobile device 102 therefore attempts to attach to a VPLMN in the location of the mobile device 102 which may be based on preferences stored in the mobile device 102 by the HPLMNO. For example, based on the stored preferences the mobile device 102 may attempt to attach to Network B. Operator B may determine or identify that the mobile device 102 is not registered or subscribed to Operator B. Operator B may then attempt to identify the HPLMNO, e.g. Operator A in this example, which the mobile device 102 is subscribed to.

2. Operator B may contact, via a roaming update message, the identified Operator A to request service information relating to the user's 109 subscription with Operator A, for example, whether or not mobile device 102 is enabled to roam according to the user's 109 subscription with Operator A. Operator B may identify the mobile device 102 to Operator A using a unique identifier, for example, the International Mobile Subscriber Identity (IMSI) number of the mobile device 102.

3. If the mobile device 102 is enabled to and successfully does attach to Operator B, then Operator B updates its management system in order to maintain a temporary subscriber record for the mobile device 102. Similarly, Operator A updates its management systems, e.g. the HLR 105 with information to identify the current location of the mobile device 102 and the VPLMNO, e.g. Operator B, which the mobile device 102 is attached to so that any communication for the mobile device 102 can be correctly routed.

Thus, conventionally the mobile device 102 automatically connects to a VPLMN, e.g. Network B, and a VPLMNO, e.g. Operator B, which may be based on the preferences of the HPLMNO, e.g. Operator A, and preconfigured in the mobile device 102. Alternatively, if no preferred VPLMN is detected then the mobile device may simply apply a set of rules to automatically select an available VPLMN. Therefore, the user 109 has no control or information regarding the available VPLMNs that the mobile device may connect to whilst roaming.

The improved communication network selection whilst roaming, according to many of the embodiments, follows on from the three general steps described hereinabove in relation to the conventional mechanism for roaming in a mobile telecommunication system. In other words, once it is known that a mobile device is roaming then the improved communication network selection may be triggered.

FIG. 2 shows a message flow diagram 201 in accordance with many of the embodiments of the present invention. The VPLMNO management system 202 of the VPLMNO, to which the mobile device 206 initially connects with or attaches to when the mobile device 206 is unable to connect to the HPLMN, for example, when the mobile device 206 is in a location that is not served by the HPLMNO, transmits a roaming update message 208 to the HLR 203 of the HPLMNO where the roaming update message may include location data for the mobile device 206 and data relating to the VPLMNO the mobile device 206 is attached to. The HLR 203 of the HPLMNO updates 209 the relevant entries in the HLR 203 (and/or any other management systems) for the subscribed mobile device 206, for example, with location data, with details of the VPLMNO, and any further relevant information or data.

In this example, the user or the HPLMNO may wish to select a VPLMN from those available based on the tariff of the VPLMNO operating the VPLMN. As will be appreciated, the user may wish to select a VPLMNO and/or VPLMN based on one or more different factors including, for example, tariff, quality of service, services/functionality provided, availability, and so on. The user may previously, e.g. before roaming, informed or provided their HPLMNO with one or more preferred criteria for selecting a VPLMNO when roaming. The user may also provide or change their preferred criteria for making their selection at any time including whilst roaming. Alternatively, the user may not provide or set any preferences or preferred criteria. Alternatively, the user may simply wish to select a VPLMNO based only on the name or identification of the VPLMNO without any further relevant information relating to each VPLMNO.

The HLR 203 on receiving the roaming update message may determine the location of the mobile device 206 based on the roaming update message, or directly from the mobile device 206. The HLR 203 may also receive a list of VPLMNs that the mobile device has detected either in the roaming update message or directly from the mobile device 206.

The HLR 203 may transmit a request message 210 to a database 204 in order to request information for one or more communication networks (e.g. VPLMNs). The request message includes one or more parameters on the basis of which the database can identify the relevant VPLMNs and information for those VPLMNs. In this example, the one or more parameters includes location data so that a list of available VPLMNs based on the location data can be obtained along with relevant information relating to each VPLMN, which, in this example, the relevant information is the tariff information for each VPLMN set by the VPLMNO.

The relevant information requested in the request message may be based on the user preferred criteria that the user has provided to their HPLMNO and the type of information requested may be included in the one or more parameters of the request message. If the user has not provided or informed the HPLMNO of their preferred criteria then the HPLMNO as default may request all information relating to each of the available VPLMNOs or only request one or more of the information that has been stored in the database 204 for each VPLMNO, for example, it may default to only requesting tariff information.

The database 204 may be maintained by the HPLMNO to store any relevant information relating to each VPLMNO that is known to the HPLMNO. The relevant information stored in the database may relate to, for example, the tariff, quality of service, services/functionalities provided, availability, and so on. The HPLMNO may receive updates from VPLMNOs when changes occur to their relevant information, may periodically request any updates from VPLMNOs, may periodically receive updates from VPLMNOs, or obtain any updates at the point in time a subscriber of the HPLMNO connects to or attaches with a VPLMN. The updates to the relevant information for the VPLMNO may then be stored in the database 204. The HPLMNO may also add or update the relevant information relating to a VPLMN when creating a new roaming agreement with a VPLMNO or updating an existing roaming agreement with a VPLMNO.

The HLR 203 may receive a response message 211 from the database 204 where the response may include a list of available VPLMNs that serve the location of the user's mobile device 206 along with any requested relevant information for each available VPLMNO. In this example, the relevant information will include the tariff for each listed available VPLMNO.

The HLR 203 generates 212 a communication message, for example, a Short Message Service (SMS) message, based on the received response message from the database 204. The communication message may also be based on the user's subscription and/or any offers or campaigns that the HPLMNO is currently running. For example, if the response message includes tariff information and the HPLMNO is running an offer of 20% off roaming costs then the communication message generated may take into account the current offer and reduce the tariff information in the response message by 20%.

In the above example, the HLR 203 receives a response from the database and generates the communication message to the roaming mobile device 206. However, as will be appreciated the database 204 may generate the communication message to the roaming mobile device 206, or any other system, server or entity in the HPLMN operated by the HPLMNO, such as a Device Management system or Subscriber Identity Module (SIM) management system.

Thus, the communication message generated by the HLR 203 may, for example, include a list of available VPLMNs along with relevant information relating to each available VPLMN operated by a VPLMNO, which in this example includes the tariffs of each VPLMNO.

If the communication message is an SMS message then the HLR 203 transmits the SMS message 213 to the Short Message Service Centre (SMSC) 205. The SMSC 205 may then transmit the SMS message 214 to the mobile device 206 of the user. On receipt of the SMS message, the mobile device 206 is able to display the SMS message to the user. The user on viewing the SMS message may then identify the preferred VPLMN based on the content and information of the SMS message. The user may select or input 215 the preferred VPLMN into their mobile device 206 that the user wishes to utilise whilst roaming in their current location. For example, the SMS message may provide the list of available VPLMNs as a list of selectable links so that the user may click on the selected VPLMN 207. Alternatively, the SMS message may include a series of commands and data which may be interpreted by the mobile device 206 or by an application on the mobile device 206 to generate a graphical user interface for the user enabling the user to select from the graphical user interface their preferred VPLMN.

The communication message is described in the example as an SMS. However, as will be appreciated the communication message may be any message that provides the information for each of the identified visitor communication networks (VPLMNs), for example, an MMS, OMA DM message, an e-mail, a web page, and so on.

By providing the list of available VPLMNs along with any relevant information as a selectable list to the user, then the user can highlight and select their preferred VPLMN which may cause the mobile device 206 to automatically connect to or attach with the selected VPLMN. Therefore, the user may not need to remember which of the listed available VPLMNs their preferred VPLMN is, and then locate the appropriate settings in their mobile device to manually force or initiate the mobile device 206 to attach to their preferred VPLMN.

Once the user has selected their preferred VPLMN from the communication message or the generated graphical user interface based on the communication message then the mobile device 206 attaches 216 to the selected VPLMN 207 automatically. The mobile device may also store the selected VPLMN as a preferred VPLMN in the memory of the mobile device.

The mechanism for selecting a preferred VPLMNO described hereinabove will now be explained in relation to the example shown in FIG. 1.

User 109 has a subscription with Operator A, e.g. the HPLMNO, in order to transmit and receive communication from their mobile device 102 via Network A, e.g. HPLMN 104. Thus, whilst mobile device 102 is in an area served by Network A 104 and Operator A then the mobile device 102 will attach to Network A 104 and Operator A.

However, in the example shown in FIG. 1, mobile device 102 is roaming and in a location that is not served by Operator A and Network A 104 but is served by Operator B of Network B 103 and Operator C of Network C 108. The mobile device 102 initially attaches to a BTS 110 in Network B, where the decision to attach to Operator B may be based on Operator A's preferences stored in the mobile device 102. On attaching to Network B 103, Operator B informs Operator A of the mobile device's 102 via a roaming update message that the mobile device 102 is roaming and attempting to connect to Network B. The roaming update message, in this example, includes location data of the mobile device 102.

Operator A updates its HLR 105 with the data and information provided in the roaming update message, e.g. the location data of mobile device 102 and with details of Operator B so that communication for the mobile device 102 can be correctly routed by the Operator A, e.g. the HPLMO.

The location data received by Operator A may identify the actual location of the mobile device 102 or may include information, e.g. the Mobile Country Code (MCC) and Mobile Network Code (MNC) of the VPLMN, or an address of the network element in the VPLMN that is communicating with Operator A, which enables Operator A to identify the actual location of the mobile device 102.

The mobile device 102 may also be identified to Operator A by a unique identifier such as the mobile device's 102 International Mobile Subscriber Identity (IMSI) or Mobile Subscriber Integrated Services Digital Network (MSISDN) number, so that Operator A can identify the mobile device 102 that is roaming.

The HLR 105 may then request, information for one or more communication networks, e.g. VPLMNs from the database 106 based on one or more parameters in the request message. In this example, the one or more parameters include location data and that the information is to include the tariff information for the VPLMNs and the associated VPLMNOs.

One or more relevant information, e.g. functionality, availability, quality of service, tariff, etc., may be requested or the requested relevant information may be based on preferences provided by the user 109 or HPLMN operator. In this example, Operator A will request tariff information (the relevant information) for each available VPLMN serving the location of the mobile device 102.

The database 106 may identify the relevant available VPLMNs and the associated information based on the one or more parameters of the request message.

The HLR 105 may receive a response message from the database 106 where the response message will include a list of available VPLMNs that serve the location of the mobile device 102. The response message will also include relevant information for each of the identified available VPLMNs. As mentioned hereinabove, in this example, the relevant information is the tariff of each VPLMNO operating the VPLMN. As shown in FIG. 1, the location of the mobile device 102 is served by both Operator B via Network B 103 and Operator C via Network C 108. Thus, the database 106 will identify, based on the location data of the mobile device 102, that both Network B operated by Operator B and Network C operated by Operator C serve the location of the mobile device 102 and therefore include those identified VPLMNs and VPLMNOs and their tariffs in the response message to the HLR 105.

The HLR 105 may then, based on the received response message from the database 106, generate a communication message, e.g. an SMS message, that includes the list of available VPLMNs along with each VPLMNOs tariff information. Therefore, the SMS message may include, for example:
Network B, Operator B—£1.20/min (current network)
Network C, Operator C—£1.00/min

The HLR 105 may also indicate which of the available VPLMNs, in this case Network B, which the mobile device 102 is currently attached to. The example SMS message above also only indicates the tariff for voice communication for simplicity of the example. However, as will be appreciated, the SMS message may include the tariff of each VPLMNO for one or more of voice communication, data communication, messaging communication, video communication, Internet browsing, and so on. The received message may also include HPLMNO preferences for the VPLMN selection, so that the HPLMNO can encourage, influence or persuade the selection of the VPLMN.

The user 109, on viewing the SMS message on their mobile device 102 will identify that Operator C has the cheaper tariff of the available VPLMNs and thus may select Operator C by, for example, clicking on or selecting Network C, Operator C from the SMS message. The mobile device 102 may then initiate a transfer or handover to Network C 108 from Network B 103 so that the mobile device 102 can utilise Network C 108 and the services provided by Operator C.

Whilst the mobile device 102 is roaming it may periodically provide location updates to its HPLMNO which enables the HPLMNO to identify or determine if there are any changes to the available VPLMNs or to the relevant information relating to the available VPLMNs, e.g. any changes to one or more of the tariffs of the associated VPLMNO, the quality of service, the availability, the services/functionalities provided, and so on. If the HPLMNO determines or identifies any changes then the HPLMNO may transmit another communication message to the mobile device of the user in order to provide the user with a further choice as to the VPLMNO they would prefer to attach to.

As an option, as HPLMNO knows the roaming mobile device location and the VPLMN/VPLMNO it is connected to, so if there are changes in roaming information, HPLMNO may automatically trigger update of roaming information for the roaming mobile device.

Accordingly, many of the embodiments described hereinabove enable a user of a mobile device to be provided with a list of available VPLMNs along with any relevant information for each VPLMN and/or the associated VPLMNO so that the user can advantageously choose or select their preferred VPLMN to connect to whilst roaming.

In many of the embodiments described hereinabove the HLR of the HPLMNO requests available VPLMNs along with any associated relevant information and generates the communication message to be transmitted to the mobile device. However, as will be appreciated those steps may alternatively be implemented by a specific system or by any other network element or management system of the HPLMNO or in the HPLMN.

The database storing information relating to each VPLMN and the associated VPLMNOs (e.g. coverage areas, tariff, quality of service, and so on) may be separate, but operatively connected to, the entity, e.g. HLR, requesting a list of available VPLMNOs in a given location. The database may alternatively form part of the entity, e.g. HLR, requesting a list of available VPLMNOs in a given location. The database may also be part of charging system or device management system.

In the above described example, the one or more parameters of the request message included location data for the roaming mobile device. However, as will be appreciated, the one or more parameters may include one or more communication networks that may have been detected by the roaming mobile device on which the user of the roaming mobile device may wish to receive information on. This may enable the user to make an informed selection of the detected communication networks rather than any arbitrary selection based on noting more than a name of the VPLMN that the user may presently have the ability to do.

Also, in the above examples in order to simplify the explanation of the embodiments the visitor communication networks were VPLMNs e.g. mobile telecommunication networks. However, as will be appreciated, mobile telephones can also communicate via Wi-Fi networks, WiMAX networks, LTE networks, Bluetooth networks, and so on. Therefore, the database may identify any type of communication network that the mobile device may connect to, based on the one or more parameters in the request message, for example, it may identify all types of available communication networks that serve a particular location of the roaming mobile device.

In the above described embodiments, the mobile device was a mobile telephone that was roaming. However, as will be appreciated, the mobile device may be any mobile device, e.g.

laptop, tablet device, and so on. In this case, once the home CSP detects that the mobile device is roaming, e.g. needing to connect to a communication network not operated by the home CSP then a network element in the Home CSP's network can trigger the process of requesting information for one or more communication networks. For example, if the mobile device is a tablet device which may require a data connection then once the Home CSP is aware that the tablet device is roaming then the Home CSP may request information regarding the communication networks that the tablet device may connect to, e.g. those data networks in the location of the tablet device. The tablet device may then receive an e-mail, web page, operator specific message or any other communication message with information for the available relevant communication networks enabling the user of the tablet device to select their preferred communication network.

Accordingly, the present invention as claimed enables an improved communication network selection on a mobile device.

While preferred embodiments of the invention have been shown and described, it will be understood that such embodiments are described by way of example only. Numerous variations, changes and substitutions will occur to those skilled in the art without departing from the scope of the present invention as defined by the appended claims. Accordingly, it is intended that the following claims cover all such variations or equivalents as fall within the spirit and the scope of the invention.

1. A method comprising:
generating a request message relating to a roaming mobile device wherein said request message includes one or more parameters and requests information for one or more communication networks based on said one or more parameters; and
transmitting said request message to a database;
such that a communication message is transmitted to said roaming mobile device wherein said communication message includes said one or more communication networks and said information for each of said one or more communication networks to enable a selection of one of said one or more communication networks.

2. The method as claimed in claim 1 in which said one or more parameters includes location data for a location of said roaming mobile device.

3. The method as claimed in claim 1 in which said one or more parameters includes one or more detected communication networks that were detected by said roaming mobile device.

4. The method as claimed in claim 1 further comprising:
receiving a response message from said database wherein said response message includes information for one or more communication networks identified by said database based on said one or more parameters;
generating said communication message based on said received response message; and
transmitting said communication message to said roaming mobile device.

5. The method as claimed in claim 1 further comprising:
receiving one or more criteria; and
wherein said one or more parameters in said request message includes said one or more criteria.

6. The method as claimed in claim 1, further comprising:
receiving a roaming update message wherein said roaming update message relates to said roaming mobile device.

7. An apparatus comprising:
a first processor adapted to generate a request message relating to a roaming mobile device wherein said request message includes one or more parameters and requests information for one or more communication networks based on said one or more parameters; and
a first output adapted to transmit said request message to a database;
such that a communication message is transmitted to said roaming mobile device wherein said communication message includes said one or more communication networks and said information for each of said one or more communication networks to enable a selection of one of said one or more communication networks.

8. The apparatus as claimed in claim 7 in which said first processor is further adapted to include location data for a location of said roaming mobile device in said one or more parameters of said request message.

9. The apparatus as claimed in claim 7 in which said first processor is further adapted to include one or more detected communication networks that were detected by said roaming mobile device in said one or more parameters.

10. The apparatus as claimed in claim 7 further comprising:
a first input adapted to receive a response message from said database wherein said response message includes said information for one or more communication networks identified by said database based on said one or more parameters;
a second processor adapted to generate said communication message based on said received response message; and
a second output adapted to transmit said communication message to said roaming mobile device.

11. The apparatus as claimed in claim 7 further comprising:
a first input adapted to receive one or more criteria; and
wherein said first processor is further adapted to include said one or more criteria in said one or more parameters of said request message.

12. The apparatus as claimed in claim 7, further comprising:
a first input adapted to receive a roaming update message wherein said roaming update message relates to said roaming mobile device.

13. (canceled)

14. A method comprising:
receiving a request message relating to a roaming mobile device wherein said request message includes one or more parameters and requests information for one or more communication networks based on said one or more parameters; and
identifying said information for said one or more communication networks based on said one or more parameters;
such that a communication message is transmitted to said roaming mobile device wherein said communication message includes said one or more communication networks and said information for each of said one or more communication networks to enable a selection of one of said one or more communication networks.

15. The method as claimed in claim 14 in which said one or more parameters includes location data for a location of said roaming mobile device.

16. The method as claimed in claim 14 in which said one or more parameters includes one or more detected communication networks that were detected by said roaming mobile device.

17. The method as claimed in claim 14 further comprising:
generating a response message wherein said response message includes said identified information for said one or more communication networks; and
transmitting said response message to an originator of said received request message.

18. The method as claimed in claim 14 further comprising:
generating said communication message based on said identified information for said one or more communication networks; and
transmitting said communication message to said roaming mobile device.

19-26. (canceled)

27. The apparatus as claimed in claim 8 further comprising:
a first input adapted to receive a response message from said database wherein said response message includes said information for one or more communication networks identified by said database based on said one or more parameters;
a second processor adapted to generate said communication message based on said received response message; and
a second output adapted to transmit said communication message to said roaming mobile device.

28. The apparatus as claimed in claim 8 further comprising:
a first input adapted to receive one or more criteria; and
wherein said first processor is further adapted to include said one or more criteria in said one or more parameters of said request message.

29. The apparatus as claimed in claim 10 further comprising:
a second input adapted to receive one or more criteria; and
wherein said first processor is further adapted to include said one or more criteria in said one or more parameters of said request message.
